(19) United States
(12) Patent Application Publication
(10) Pub. No.: US 2021/0331101 A1
(43) Pub. Date: Oct. 28, 2021

(54) LIQUID ELIMINATING CARTRIDGE

(71) Applicant: Welker, Inc., Sugar Land, TX (US)

(72) Inventors: Josh H. Welker, Richmond, TX (US); Hung Ngoc Pham, Houston, TX (US)

(21) Appl. No.: 17/238,827

(22) Filed: Apr. 23, 2021

Related U.S. Application Data
(60) Provisional application No. 63/016,429, filed on Apr. 28, 2020.

(51) Int. Cl. B01D 35/30; B01D 36/00

(52) U.S. Cl. CPC B01D 35/30; B01D 36/001; B01D 2201/29; B01D 2201/34; B01D 2201/304

(57) ABSTRACT

The present invention provides a liquid eliminating cartridge that is formed by snapping two mating pieces together. The pieces may include a body portion and a top portion and may together clamp an oleophobic/hydrophobic membrane there between.

### CROSS-REFERENCE TO RELATED APPLICATIONS

This Application claims priority to U.S. Provisional Patent Application Ser. No. 63/016,429, filed on Apr. 28, 2020, entitled “LIQUID ELIMINATING CARTRIDGE” currently pending, the entire disclosure of which is incorporated herein by reference.

### BACKGROUND OF THE INVENTION

Liquid eliminators are utilized to remove liquid from a gas sample. By doing so, they may prevent downstream analyzers that measure the integrity of the sample from being damaged. Filters are used in the liquid eliminators to help filter out the liquid. The filters include an oleophobic/hydrophobic membrane which is aligned with the rest of the filter for the eliminator to be effective. Doing so can be a challenge, and if the membrane is not properly aligned, the assembly can leak. A solution is desired that provides a filter that allows the membrane to easily be replaced. The solution should be reliable, repeatable, and easy to assemble.

### SUMMARY OF THE INVENTION

The present invention is a liquid eliminating cartridge. The cartridge is preferably created by engaging two mating pieces together. The pieces may include a body portion and a top portion and may together clamp an oleophobic/hydrophobic membrane there between.

The mating pieces may each include a specifically designed lipped portion that allows a user to snap the pieces together using only his or her hands. The polytetrafluoroethylene (e.g., Teflon®) pieces and the membrane may seal to prevent fluids from passing through the cartridge. The snapping of the mateable lipped portions preferably retain the membrane in the cartridge and keep it from blowing out. The resulting cartridge is simple, repeatable, and reliable to assemble and replace.

### BRIEF DESCRIPTION OF THE DRAWINGS

FIG. 1 is a first perspective view of a first embodiment of a liquid eliminator.

FIG. 2 is a second perspective view of the first embodiment of the liquid eliminator illustrated in FIG. 1.

FIG. 3a is a cross-section view of the first embodiment of the liquid eliminator of FIGS. 1 and 2.

FIG. 3b is a cross-section view of an alternatively constructed version of the first embodiment of the liquid eliminator of FIG. 3.

FIG. 4 is a first perspective view of a second embodiment of a liquid eliminator.

FIG. 5 is a second perspective view of the second embodiment of the liquid eliminator of FIG. 4.

FIG. 6 is a cross-section view of the liquid eliminator of FIGS. 4 and 5.

FIG. 7 is a perspective view of a first embodiment of a disposable liquid eliminator cartridge constructed according to the teachings of the present invention.

FIG. 8 is an exploded view of the disposable liquid eliminator cartridge of FIG. 7.

FIG. 9 is a cross-section view of the disposable liquid eliminator cartridge of FIGS. 7 and 8.

FIG. 10 is a perspective view of a second embodiment of a disposable liquid eliminator cartridge.

FIG. 11 is an exploded view of the disposable liquid eliminator cartridge of FIG. 10.

FIG. 12 is a perspective view of the disposable liquid eliminator cartridge of FIGS. 10 and 11 during one embodiment of its manufacturing process.

FIG. 13 is a cross-section view of the disposable liquid eliminator cartridge of FIGS. 10-12.

### DETAILED DESCRIPTION OF THE INVENTION

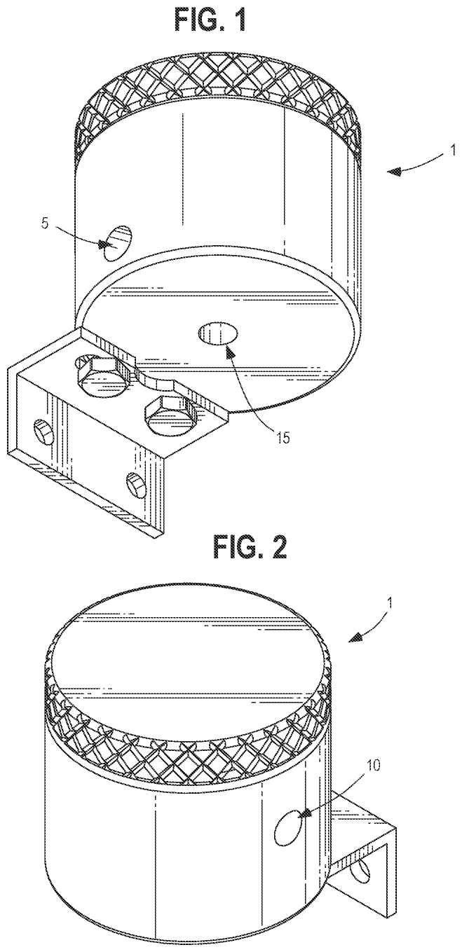

A liquid eliminator 1 is illustrated in FIGS. 1-3 that includes each of an inlet 5 and an outlet 10 (illustrated in FIG. 2). The liquid eliminator 1 further includes a bypass or drain 15 as known and understood in the art. The liquid eliminator 1 preferably acts to protect downstream analyzers (not illustrated) from damage and contamination that results when liquid comes into contact with an analyzer. The liquid eliminator 1 preferably filters out liquid from gas samples that are introduced via the inlet 5 before the gas samples subsequently exit the outlet 10. Liquid and sediment filtration within the liquid eliminator 1 preferably increases profitability by protecting sensitive equipment downstream from the liquid eliminator 1 that can be damaged by liquid.

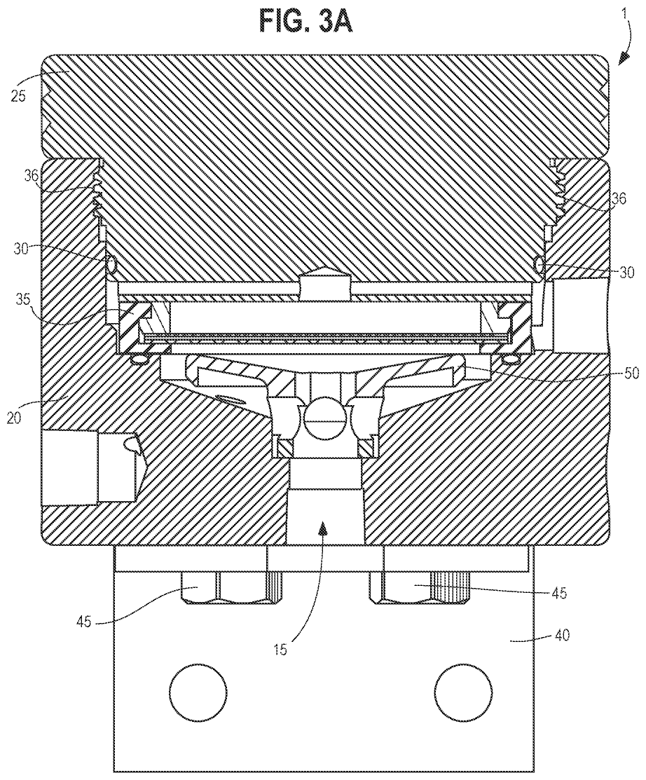

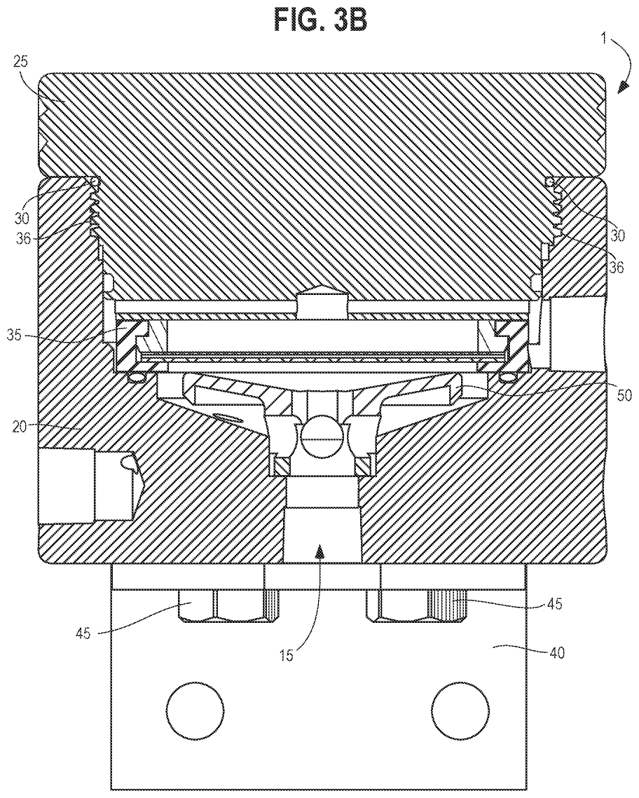

Two cross-section views of the liquid eliminator 1 are provided in FIGS. 3a and 3b, where the liquid eliminator 1 is constructed slightly differently in FIG. 3a than in FIG. 3b. In both constructions, the liquid eliminator 1 generally includes a body portion 20 to which a cap member 25 may be releasably attached. An O-ring 30 may circumscribe an inner portion of the cap member 25 to further secure the engagement between the cap member 25 and the body portion 20. A liquid eliminating cartridge 35 is preferably secured between the cap member 25 and the body portion 20. The novel cartridge 35 will be discussed in greater detail herein below.

In the illustrated embodiment of FIG. 3a, the O-ring 30 is located below engagement threads 36 where the body portion 20 and the cap member 25 are engageable with one another. During assembly, the engagement threads 36 may be coated with a lubricant (e.g., NEVER-SEEZ® lubricant, other “anti-seize” lubricant, or Impreglon® coating) that helps prevent metal to metal galling during assembly or maintenance. Such a lubricant is harmful to internal components of the analytical device to which the liquid eliminator 1 is feeding a sample. Thus, to help prevent the lubricant from entering the flow space of the liquid eliminator 1, the O-ring 30 in FIG. 3a is uniquely placed below the threads 36, thus separating the lubricant from the path to the analyzer.

In FIG. 3b, in an alternative embodiment, the O-ring 30 is illustrated at an upper portion 37 of the body portion 20 where it abuts the cap member 25.

In both of FIGS. 3a and 3b, the liquid eliminator 1 also preferably includes a bracket member 40 that is secured to the body portion 20 of the liquid eliminator 1 via screw members 45. The bracket member 40 may be used to secure the liquid eliminator 1 to a sampler or a panel. The liquid eliminator 1 may further include a thread insert cap member 50 that may be placed over the bypass or drain 15.

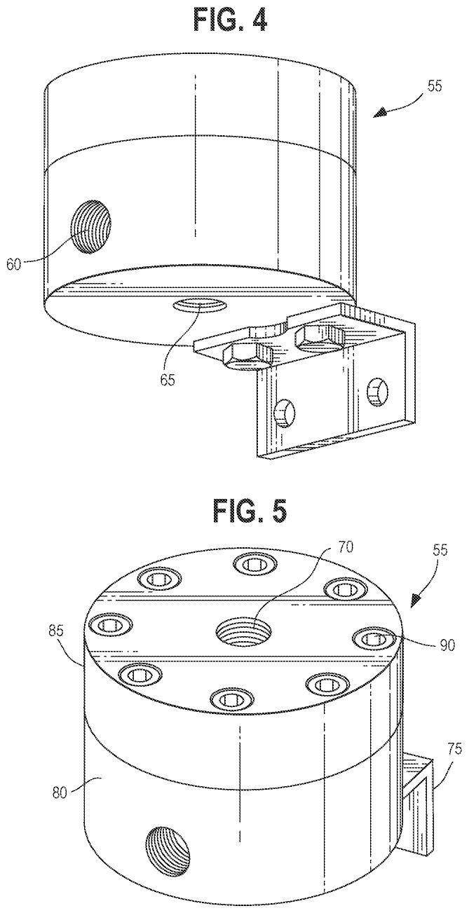

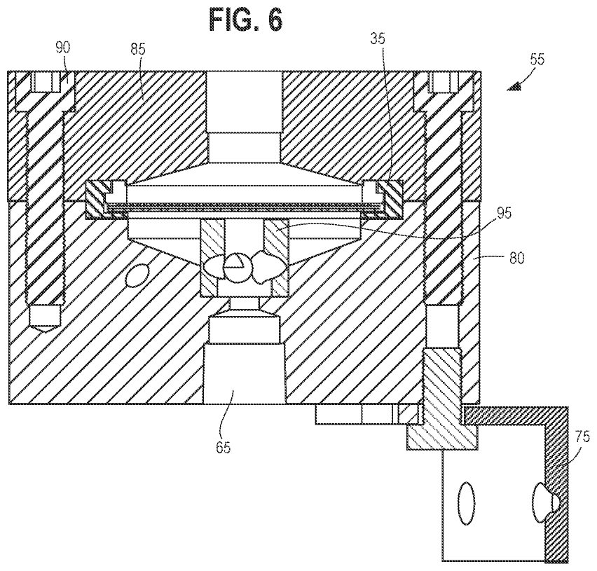

Moving now to FIGS. 4, 5 and 6, an alternative liquid eliminator, liquid eliminator 55 is illustrated. The liquid eliminator 55, like the liquid eliminator 1, preferably includes an inlet 60, bypass or drain 65, and outlet 70. It further includes a bracket member 75, and a body portion 80 that is secured to a cap member 85. In the liquid eliminator 55, the cap member 85 is preferably secured to the body portion 80 by a plurality of screws 90. Rather than a thread insert cap, such as the cap member 50 of the liquid eliminator 1, the liquid eliminator 55 is provided with a thread insert member 95 that may selectively cover the bypass 65. Like the liquid eliminator 1, a liquid eliminator cartridge is secured between the cap member 85 and the body portion 80. In the embodiment illustrated in FIG. 6, the cartridge 35 is the same cartridge as what is illustrated in FIGS. 3a and 3b and described below.

While multiple types of cartridges may be used with the liquid eliminators 1 or 55 (or other foreseeable alternatives to the liquid eliminators 1, 55), two cartridges are described herein that may be used in association with either of the liquid eliminators 1, 55. Preferably, the first cartridge 35 that is illustrated in FIGS. 3a, 3b, and 6 may be used when the pounds per square in gauge (PSIG) is between 25 and 1440 PSIG. The other cartridge member, described below in connection with FIGS. 10-13, may operate at lower pressures.

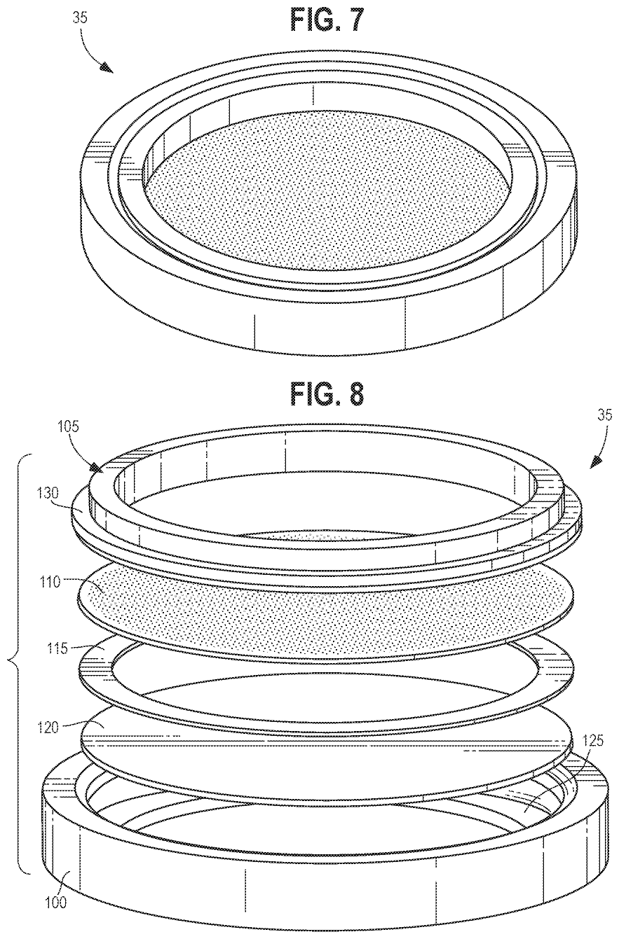

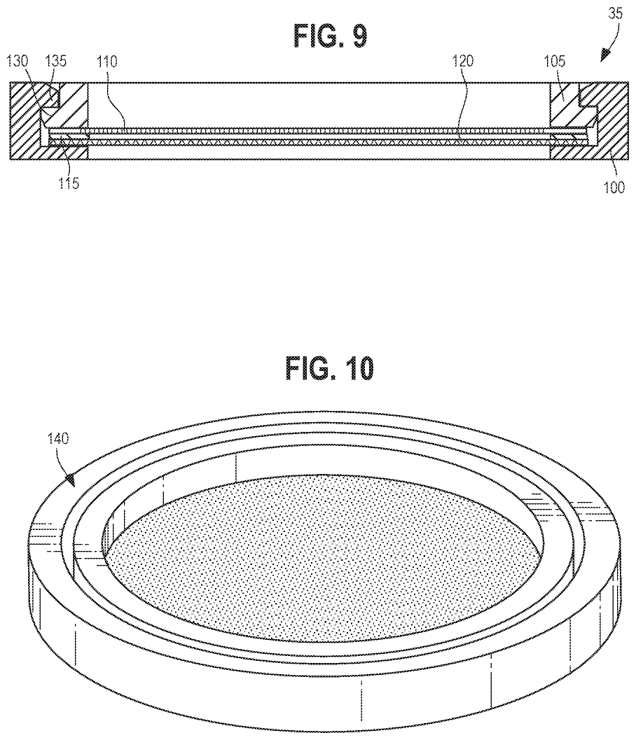

The first cartridge 35 is illustrated in detail in FIGS. 7, 8 and 9. The cartridge 35 is illustrated in its assembled form in FIG. 7, but in FIG. 8, the cartridge 35 is illustrated in an exploded view so as to show the various components that make up the cartridge 35. As illustrated in FIG. 8, the cartridge 35 generally includes each of a cartridge body member 100, cartridge top portion 105, screen member 110, washer member 115, and copolymer filter element 120. The body member 100 and top portion 105 are preferably constructed of a Teflon® or Teflon®-like material. The screen member 110 provides additional support to the cartridge 35 so that the filter element 120 is less likely to blow out when the cartridge 35 experiences high pressure flow. Those various components are also illustrated in the cross-section view of FIG. 9 when the cartridge 35 is in its assembled form.

Generally, in order to construct the cartridge 35, the copolymer filter element 120 is first placed within the cartridge body member 100 such that it is retained in place by a retention ring 125 that circumscribes an inner portion of the cartridge body member 100. The washer 115 may then be placed between the filter element 120 and the screen 110. Finally, the top portion 105 may be placed on top of the screen 110, washer 115, and filter element 120. The top portion 105 preferably includes a lipped portion 130 that projects outwardly from the top portion 105 and circumscribes the top portion 105. The lipped portion 130 is preferably mateable with a lipped portion 135 of the body portion 100.

With the lipped portions 130, 135 engaged with one another, the cartridge 35 is assembled. Because the lipped portions 130, 135 are easily mated with one another, the cartridge 35 may be constructed in a consistent and repeatable manner. That way, a user may easily replace the filter element 120 when it is in need of replacement without worry of incorrectly constructing the cartridge 35 and thus making it susceptible from leaking liquid or otherwise allowing liquid to pass through the cartridge 35 into the analyzer where it may damage the analyzer.

FIGS. 10-13 illustrate an alternative construction of a liquid eliminator cartridge, liquid eliminator cartridge 140. The liquid eliminator cartridge 140 may be used, for example, in the liquid eliminators 1, 55 instead of the cartridge 35 when pressure is between 0 and 25 PSIG. As illustrated in FIG. 11, the cartridge 140 generally includes a cartridge body member 145, a cartridge top portion 150, and a copolymer filter element 155. As such, the cartridge 140 omits a screen, such as the screen 110, and a washer, such as the washer 115, as compared to the cartridge 35. At low pressures, the extra support that the screen 110 provides may not be necessary.

Like the body member 100 of the cartridge 35, the body member 145 of the cartridge member 140 includes a lipped portion 160 that circumscribes an upper portion of the body member 145 and projects inwardly therefrom. Similarly, like the top portion 105 of the cartridge 35, the top portion 150 of the cartridge 140 includes a lipped portion 165 that protrudes outwardly from and circumscribes the top portion 150. To assemble the cartridge 140, the filter element 155 is first placed such that it is seated within the body member 145.

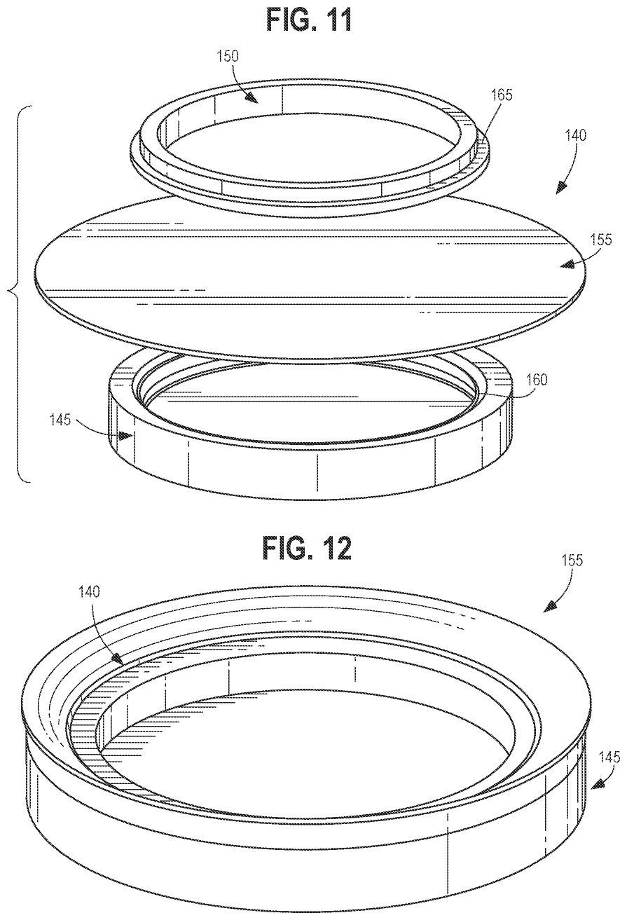

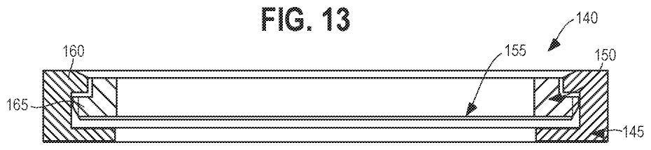

As illustrated in FIG. 12, the filter element 155 has a circumference greater than that of the body member 145. As such, prior to its use, it may need to be cut, broken, or filed such that it is of an appropriate size such as that illustrated in FIG. 10. After placing the filter element 155, such that it is seated within the body member 145, the top portion 150 may be pushed downwardly until the lipped portions 165, 160 of the top portion 150 and the body member 145, respectively, meet with one another. At this time, after the filter element 155 is cut, sawed, or trimmed as described above, the cartridge 140 is assembled in the manner illustrated in FIG. 13.

As was the case for the cartridge element 35, the cartridge 140 is constructed in a manner that allows for simple, repeated assembly. That way, when a cartridge such as the cartridge 140 is in need of replacement, a user is less likely to incorrectly assemble the cartridge 140. Misassembly of the cartridge 140 may cause leakage within the cartridge 140 or cause unwanted liquid to pass through the filter element 155 into the cartridge 140 more broadly, which may lead to damage to a downstream analyzer.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. A replaceable liquid eliminating cartridge for filtering out liquid from a sample, the replaceable liquid eliminating cartridge including:
a body member;
a top portion that is selectively mateable with the body member; and
a copolymer filter element secured between the body member and the top portion.

2. The replaceable liquid eliminating cartridge of claim 1, wherein the top portion, the body member, and the filter element may be aligned with one another to reduce misalignment errors that occur during maintenance and repairs.

3. The replaceable liquid eliminating cartridge of claim 1, wherein the replaceable liquid eliminating cartridge is configured to function for high pressure or low pressure applications.

4. The replaceable liquid eliminating cartridge of claim 1, wherein the replaceable liquid eliminating cartridge further includes a washer member between the top portion and the copolymer filter element.

5. The replaceable liquid eliminating cartridge of claim 1, wherein the replaceable liquid eliminating cartridge further includes a screen between the top portion and the copolymer filter element.

6. The replaceable liquid eliminating cartridge of claim 5, wherein the replaceable liquid eliminating cartridge further includes a washer member between the screen and the copolymer filter element.

7. The replaceable liquid eliminating cartridge of claim 1, wherein the replaceable liquid eliminating cartridge is secured within a liquid eliminator.

8. The replaceable liquid eliminating cartridge of claim 7, wherein the liquid eliminator includes a body portion and a cap member that are threadingly engageable with one another, and the liquid eliminator further includes an O-ring below an area where the body portion and the cap member are threadingly engageable with one another.

9. The replaceable liquid eliminating cartridge of claim 1, wherein the body member and the top portion are constructed of polytetrafluoroethylene.

10. The replaceable liquid eliminating cartridge of claim 1, wherein the top portion includes a first lipped portion that projects outwardly and circumscribes the top portion, and the body portion includes a second lipped portion that projects outwardly and circumscribes the top portion, and the first lipped portion and the second lipped portion are mateable with one another.

11. A liquid eliminator, the liquid eliminator comprising:
a body portion;
a cap member, the body portion and the cap member threadingly engageable with one another; and
an O-ring positioned and located below threads that are able to threadedly engage the cap member and the body portion to one another.

12. The liquid eliminator of claim 11, wherein the liquid eliminator further includes a replaceable liquid eliminating cartridge for filtering out liquid from a sample, the replaceable liquid eliminating cartridge including:
a body member;
a top portion that is selectively mateable with the body member; and
a copolymer filter element secured between the body member and the top portion.

13. The liquid eliminator of claim 12, wherein the top portion, the body member, and the filter element may be aligned with one another to reduce misalignment errors that occur during maintenance and repairs.

14. The liquid eliminator of claim 12, wherein the replaceable liquid eliminating cartridge is configured to function for high pressure or low pressure applications.

15. The liquid eliminator of claim 12, wherein the replaceable liquid eliminating cartridge further includes a washer member between the top portion and the copolymer filter element.

16. The liquid eliminator of claim 12, wherein the replaceable liquid eliminating cartridge further includes a screen between the top portion and the copolymer filter element.

17. The liquid eliminator of claim 16, wherein the replaceable liquid eliminating cartridge further includes a washer member between the screen and the copolymer filter element.

18. The liquid eliminator of claim 12, wherein the body member and the top portion are constructed of polytetrafluoroethylene.

19. The liquid eliminator of claim 12, wherein the top portion includes a first lipped portion that projects outwardly and circumscribes the top portion, and the body portion includes a second lipped portion that projects outwardly and circumscribes the top portion, and the first lipped portion and the second lipped portion are mateable with one another.

20. The liquid eliminator of claim 12, wherein the liquid eliminator includes a bracket member secured to the body portion of the liquid eliminator that may be used to secure the liquid eliminator to at least one of a sampler and a panel.
